(19) United States
(12) Patent Application Publication
(10) Pub. No.: US 2026/0061467 A1
(43) Pub. Date: Mar. 5, 2026

(54) METHOD FOR BENEFICIATING RECYCLED CONCRETE AGGREGATE AND PASTE, AND RECYCLED CONCRETE AGGREGATE AND RECYCLED CEMENTITIOUS MATERIALS PRODUCED THEREBY

(71) Applicant: Urban Mining Industries, LLC, New Rochelle, NY (US)

(72) Inventors: Louis P. Grasso, JR., New Rochelle, NY (US); Dale Hauke, Northlake, TX (US)

(73) Assignee: Urban Mining Industries, LLC, New Rochelle, NY (US)

(21) Appl. No.: 18/816,971

(22) Filed: Aug. 27, 2024

(51) Int. Cl. B09B 3/40; B09B 3/35; C04B 7/24

(52) U.S. Cl. CPC B09B 3/40; B09B 3/35; C04B 7/246

(57) ABSTRACT

Methods and systems are provided for processing post-consumer waste concrete into a usable recycled aggregate and supplementary cementitious material. The concrete is crushed and tumbled under heat and optional watering to liberate unreacted hardened cement paste. The aggregate is then screened for size for application, and the hardened cement paste is milled into a supplementary cementitious material, which can be used alone or blended with other supplementary cementitious materials such as ground glass pozzolan.

### BACKGROUND OF THE INVENTION

### 1. Field of the Invention

The present disclosure relates to concretes, aggregates and cementitious materials. More particularly, the disclosure is directed to methods of beneficiating recycled concrete aggregate and paste into products usable in new concrete products. The disclosure is also directed to the aggregate and cementitious materials produced by methods described.

### 2. State of the Art

The production and utilization of concrete is rapidly increasing. This results in increased consumption of natural aggregate as the largest component of concrete by dry weight. According to the United States Geological Survey (USGS), approximately 1.46 billion tons of aggregate were consumed in the United States in 2020. Of this, approximately 110 million tons were used in concrete products and approximately 38 million tons were recycled.

The primary uses of recycled concrete include many types of general bulk fills, bank protection, base or fill for drainage structures, road construction, noise barriers, embankments, riprap revetments, landscaping stone, wire gabion retaining walls and privacy screens. Unfortunately, very little recycled concrete is used to make new concrete. One reason for the lack of utilization of recycled concrete aggregates (RCA) in new concrete is that the porous and cracked residual hardened cement paste (HCP) attached to the RCA has a significant negative effect on the quality of concrete made with RCAs. The properties negatively affected by RCAs compared to natural virgin aggregates (NVAs) include the following:
water absorption increase up to 50%;
decrease in compressive strength up to 25%;
increased drying shrinkage up to 50%;
increased creep up to 50%;
decreased splitting and flexural tensile strength up to 10%;
decreased modulus of elasticity up to 45%;
decreased frost resistance;
decreased bulk density;
decreased specific gravity;
increased abrasion loss; and
increased crushability.

Previously, the only known way to utilize RCA in the manufacture of an acceptable concrete is to treat the RCA by one of several methods. The most common treatment is to prewet the RCA so that the residual cement paste in the recycled concrete and stuck on the aggregate is saturated with moisture, but at the same time the surface of the aggregate is in a relatively dry condition. To achieve suitable workability, slump, and water-cement ratio comparable to conventional concrete, the paste content or amount of water reducer must be increased requiring costly chemical additives to the concrete.

There has been research on methods to mitigate the deleterious effects of RCA in new concrete. One method is to coat the surface of the RCA with an inorganic material (e.g., fly ash, slag, etc.), thus improving the surface properties of RCA and hence the interfacial transition zone (ITZ). The ITZ is the region of the cement paste directly adjacent the aggregate surface and is responsible for the bond between the aggregate and the cement paste. As such, an improved ITZ enhances the mechanical structural properties of the resultant concrete. Other methods include polymer-based treatments that lower water absorption and yield better fragmentation resistance, and consequently stronger concrete. Yet other methods have investigated treatment of the recycled aggregate by impregnation of silica fume solution, which has shown an increase in compressive strength of 30% over untreated recycled aggregate. Another study using an ultrasonic cleaning treatment of the recycled concrete led to an improvement in compressive strength of 7%. Yet even with the various research results, there has been little success in a uniform treatment of recycled concrete that can result in a recycled aggregate and other cementitious products that can be used without additives controlling variables that occur when receiving recycled content from multiple resources. A processing facility will be expected to receive and process concrete from multiple sources and projects and make the resulting product available as a bulk material for others which can be placed, or proportionally replaced, into a new concrete project without significant concern regarding the necessity for knowing its origin, type or a quantity of associated required additives needed for the source of the materials.

As such, a significant barrier to utilization of recycled aggregates is the variability in the amount and type of hardened paste retained on the stone aggregates and its effect on consequent concrete. The amount of residual paste is primarily a function of the type of aggregate (e.g., limestone, quartz, trap rock, etc.), the type of cement and pozzolan originally used in the concrete, and the original compressive strength of the recycled concrete. Since it is impossible for the concrete recycler to control these variables when the recycled aggregate can be received from multiple sources, the use of RCAs in new concrete has been limited to a relatively small percentage of total aggregate despite the mitigation technologies heretofore described.

### SUMMARY OF THE INVENTION

Concrete waste is obtained from waste sources, including deconstruction of buildings. The concrete waste includes recycled aggregate having hardened cement paste on its surface. The concrete waste is crushed and processed in a beneficiating process to produces multiple products, including a processed recycled concrete aggregate suitable for new concrete products, a processed recycled concrete paste, and optionally one or more of road base, structural fill and/or flowable fill materials. The method for making the processed recycled concrete aggregate and processed recycled concrete paste involves two key steps: (1) processing the crushed waste concrete in a rotary drum to abrade the hardened cement paste (HCP) off the RCA producing the processed recycled concrete aggregate and (2) processing the HCP in a grinding device to liberate the unreacted portland cement and supplementary cementitious materials (SCMs) contained in the HCP to produce the processed recycled concrete paste.

Portland cement is the primary component of cement paste. Cement clinker is made from calcium carbonate, clay and other raw materials that are crushed, blended, and calcined in a cement kiln. The cement clinker is then milled in a fine-grinding device yielding portland cement. The size of a cement particle has an important effect on the rate at which it will hydrate when exposed to water. As portland cement reacts, a layer of hydration product forms around the outside of the cement particle, separating the unreacted core of the particle from the surrounding water. As this layer grows thicker, the rate of hydration slows down. Therefore, a small cement particle will react both more quickly and thoroughly than a large cement particle. A cement particle that has a diameter of 1 μm will react completely in about 1 day, whereas a particle with a diameter of 10 μm will react completely in about 1 month. Particles larger than about 50 μm will never become fully reacted, even if there is a sufficient source of water.

Typical portland cement has a median particle size (d50) of approximately 18 μm and a d95 of 67 μm (i.e., 95% of the particles are less than 67 μm in size). Approximately 10% of the cement particles, by quantity, are greater than 50 μm and particles can be as large as 100 μm. Therefore, there is a significant quantity of unreacted portland cement contained in the HCP of the waste concrete.

Supplementary cementitious materials (SCMs) include pozzolans such as fly ash, which is a by-product of coal-burning during electric generation, slag “cement” or ground granulated blast furnace slag, silica fume, metakaolin, and natural pozzolans including volcanic ash. Since SCMs, and particularly pozzolans, improve the strength and durability of concrete, most concrete today replaces a portion of the portland cement with an SCM. ASTM C 618, the standard specification for fly ash and other natural pozzolan use in concrete allows up to 34% of the particles to be larger than 45 μm when used as a partial replacement for portland cement. These large particles have small or negligible participation in the pozzolanic reaction and hence are left largely intact in the HCP. The same phenomenon causing unreacted portland cement occurs with slag cement.

Although the larger particles of SCMs and portland cement provide little cementitious value in the cement paste, the outer surface of the particles are reacted which creates a protective sheath preventing further reaction. It has been found that unreacted cement and SCMs can be liberated by breaking them apart with a fine grinding device yielding reduced particle size and exposing the unreacted surface area of the cementitious particles. This liberation restores the reactivity of the unreacted cement and SCMs contained in the HCP, thereby producing processed recycled concrete paste.

### BRIEF DESCRIPTION OF THE DRAWINGS

FIG. 1 is a flow chart for a processing waste concrete into post-consumer recycled products

FIG. 2 is photograph of a surface of a sample piece of aggregate pre-processing.

FIG. 3 is a photograph of a surface of another sample piece of aggregate post-processing.

FIG. 4 is a grid set out on a photograph of a surface of a sample piece of aggregate post-processing, identifying clean relative to residual hardened cement paste (HCP) on the surface of the aggregate.

### DETAILED DESCRIPTION OF THE PREFERRED EMBODIMENTS

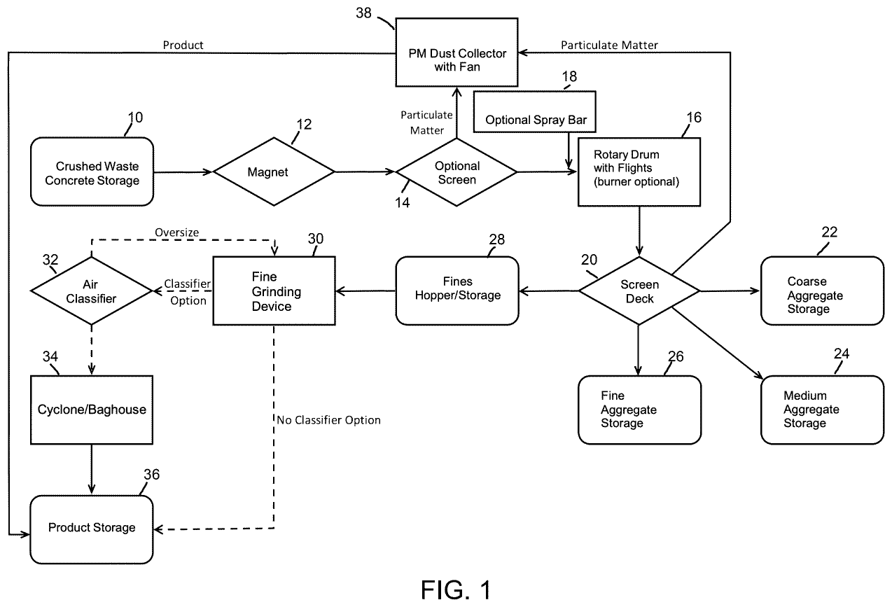

Turning now to FIG. 1, a flow chart is shown for a general process of beneficiating waste concrete into post-consumer recycled products. The recycled products as described below include, but are not limited to, processed recycled concrete aggregate and processed recycled cementitious product.

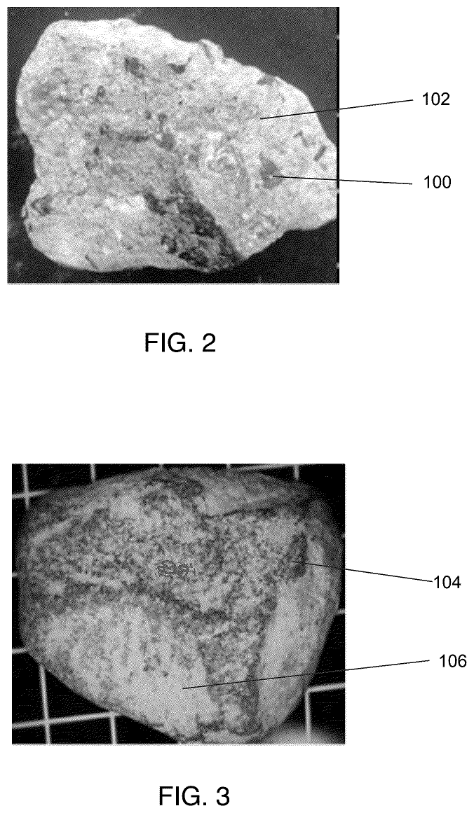

The raw material is waste concrete. The waste concrete is any type of post-consumer concrete source, including, but not limited to, concrete masonry units and other block, concrete wall units, concrete barriers, concrete cast structures, concrete road surfaces, and other concrete forms. The waste concrete can be obtained from deconstruction of buildings or any other post-consumer concrete source material. It is preferable that the concrete is pre-processed by crushing to break the concrete into processable loads and to remove a majority of ferrous metal reinforcing bar and wire mesh. As shown in FIG. 2, the crushed concrete generally includes aggregate 100 up to completely (100%) coated with cementitious product 102, and most often at least 90% coated with cementitious product, although sometimes having a lower percentage of cementitious product coating. The cementitious product may be coated in areas of thin and/or thick layers over the aggregate. The crushed concrete is preferably loaded into a storage bin and is available to be fed or delivered from a storage 10.

The crushed concrete is moved from storage 10, and the crushed concrete and a magnet 12 are moved relative to each other. The crushed concrete may be moved on a conveyor system past a magnet station, or a magnet may be moved relative to an array of the concrete. Any suitable magnetic system 12 for significantly reducing the ferrous load in the crushed concrete can be used. The magnet 12 removes remaining ferrous metal in the crushed concrete.

It is expected that a portion or all of the waste concrete is from sources that may have had contact with soil (e.g., concrete foundations, pavement, etc.). Contaminant soil can dilute the processed recycled cementitious product and reduce its reactivity. A vibratory or rotary screen system 14 is used to screen dirt content if the dirt content on the concrete is too high. The screening process can be optional, implemented if the dirt content exceeds a predetermined level (by visual inspection, by location of concrete origin, or by sample testing) or can be a persistent station of the concrete processing used regardless of soil content. The aperture size of the screen in the screening process 14 can depend on the size of the dirt particles. This may be a function of the crusher technology implemented in preparing the post-consumer concrete for concrete storage 10, as well as the moisture content of the soil in the concrete. If the soil is very dry, as would be expected in arid regions, the soil breaks down to smaller particle sizes, requiring a smaller screen aperture to remove the soil. In wet climates or other wet conditions, the soil particles will be larger and clumpier requiring larger screen apertures. The material screened out in this process can be used in structural fill applications including flowable fill which is a controlled low strength cementitious fill.

After optionally screening the dirt from the concrete, the crushed concrete is moved into a rotary drum 16. The rotary drum has a feed end, a discharge end, and abrades the hardened cementitious paste from the concrete aggregate in the crushed concrete as the crushed concrete is moved through the drum from the feed end to the discharge end. The rotary drum preferably has internal lifters (baffles). As the drum rotates about a longitudinal axis that extends between the feed and discharge ends, the lifters raise the crushed concrete to near the top of the drum rotation before the crushed concrete falls in a cascading motion to the bottom of the drum. This cascading action abrades residual HCP from the aggregate in the concrete. Sufficient residence time in the rotary drum will polish the aggregate to a suitable degree such that a significant portion of the surface of the aggregate is exposed. If the original virgin aggregate was originally smooth, a significant portion of the resulting treated aggregate is clean and smooth. If the original virgin aggregate had a rough surface, the resulting treated aggregate will have some remaining HCP on the surface, particularly in the indentations. However, the treated aggregate will have a surface structure different than either virgin aggregate or merely loosed aggregate from crushed concrete. If the waste concrete is dry, such as might be in arid climates, the rotary drum may be able to be used without heat. Alternatively, when the concrete may be wet or damp, the rotary drum is preferably outfitted with a burner (called a rotary dryer). The rotary dryer can be either a parallel flow system or countercurrent flow system. In a parallel flow rotary dryer, a burner generating heat is provided at the feed end for the crushed concrete, and the heat is blown parallel to the flow of crushed concrete material from one end to the other of the drum. The intense heat from the burner near the in-feed flash dries the HCP on the waste concrete aggregate making the process of abrading the HCP from the waste concrete aggregate more efficient. This minimizes the amount of energy required to clean and polish the aggregate. In a countercurrent flow dryer, the burner generating heat is positioned at a discharge end of the drum, and the heat is blown counter to the flow of material, toward the feed end. Regardless of the process and system used to heat and dry the waste concrete aggregate, once the HCP is dry, it is more easily abraded off the aggregate by the tumbling action in the rotary drum.

Aggregates used in concrete typically have rough surfaces which can trap small amounts of HCP that cannot be abraded in the drum. To remove high quantities of the HCP from indentations and cervices on the aggregate surface, the differential swelling of the aggregate and the HCP retained in the crevices of the aggregate when both the aggregate and HCP are subject to heat is utilized.

Using a less energy-efficient countercurrent flow rotary dryer (burner integrated with rotary drum), the waste concrete aggregate passes the flame just prior to discharge from the drum. This maximizes the surface temperature of the waste aggregate upon discharge. This elevated temperature maximizes the differential expansion of the aggregate and HCP leaving the drum, resulting in the embedded HCP popping out of the indentations and crevices. Turning to FIG. 3, this produces a cleaner processed recycled concrete aggregate 104, with only small amounts of HCP 106 remaining in the deepest crevices and indentations. This also generates an additional quantity of HCP for further processing. Effectively, at least 30% of the surface area of the aggregate is exposed, more preferably at least 40% of the surface area of the aggregate is exposed, and even more preferably at least 50% of the surface area of the aggregate is exposed.

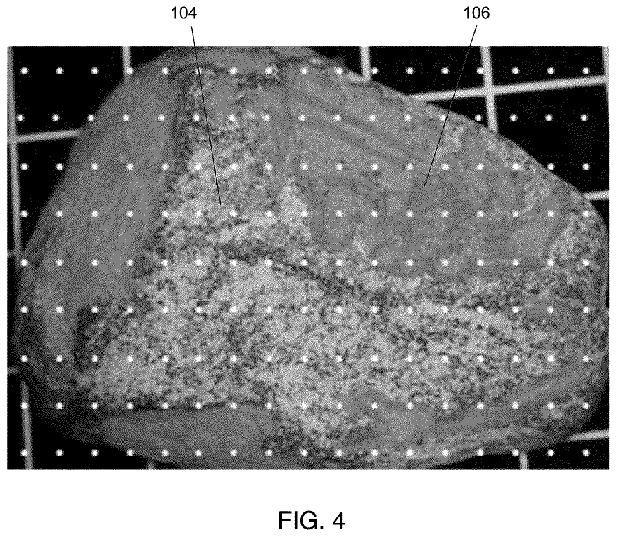

In exemplar FIG. 4, a dot grid is positioned on an image of a cleaned aggregate. The dot grid can be used to calculate the relative surface areas on the aggregate which are clean (exposed stone) and unclean (stone still partially covered with HCP), as follows:

$$\frac{( Number of dots free of HCP \times 100 )}{( Total number of dots )} .$$

Manually counting the dots in each areas of the image reveals that the exemplar piece of aggregate has surface areas 104 exposed over 56% over its surface; i.e., the exposed areas of the cleaned sample aggregate are completely or substantially visually free of HCP. Moreover, the remaining area containing HCP 106 is significantly reduced in coating thickness of HCP than prior to processing.

The images may also be processed and the clean surface area calculated using software. For example, the image can be digitized and uploaded into AutoCad or another suitable software program that will calculate and display the clean and coated surface areas electronically.

In an alternate method that further enhances removing HCP from indentations and crevices, the crushed concrete is subject to wetting from a spray bar at 18 before the crushed concrete enters the dryer of a parallel flow dryer. The water from the spray bar is quickly absorbed by the HCP. Then, when the concrete aggregate enters the dryer, it is immediately exposed to the flame near the feed end. The temperature of the flame is generally in the range of 1500 to 1900° F. and more preferably 1,700 (±200)° F. The absorbed water is flash dried and causes the HCP to pop away from the aggregate.

The concrete is conveyed from the rotary drum 16, normally via a conveyor, to a screen deck 20 that contains screens of a sufficient size differentiation to sort the clean aggregates into the desired products. In one embodiment, screens are employed to separate the concrete material into course processed recycled aggregate (−1″, +⅜″), which is transferred to course aggregate storage 22, medium processed recycled aggregate (−⅜″, +10 mesh), which is transferred to medium aggregate storage 24, and fine processed recycled aggregate (−10 mesh, +40 mesh), which is transferred to fine aggregate storage 26. Additional screens can be utilized to sort and capture aggregates into additional sizes ranges.

The smaller material is allowed to pass through the screen deck 20 and is not considered aggregate. These fines are smaller than sand and on the order of −40 mesh in size. The fines material is preferably collected in a hopper or storage 28. The primary component of these fines is the HCP that was abraded away from the aggregates. The HCP contains both reacted and unreacted portland cement and SCMs that were used in the original concrete mix designs. The unreacted portion of the HCP has cementitious properties once properly liberated. The SCMs in the HCP may potentially include, but are not necessarily limited to, fly ash, natural pozzolans, ground granulated blast furnace slag, metakaolin and silica fume.

The larger cement and SCM particles do not fully react in the original concrete. While the surface of these particles has reacted, the interior remains unreacted by the nature of the original process of making cement. The unreacted portion of the particles is liberated by transferring the “fines” to a fine grinding device 30 to produce processed recycled concrete paste. A suitable fine grinding device 30 includes, but is not limited to, a ball mill, tube mill, stirred media mill, roller mill, high velocity impact mill, vibratory mill, a high pressure grinding roll (HPGRs), a vertical shaft impactor, and any other type of grinding device sufficiently robust to liberate the unreacted materials. The “fines” are maintained in the fine grinding device for a suitable residence time and under suitable force to break up the larger particles and expose the unreacted material. The target top particle size is approximately 45 microns but can be higher or lower depending on the performance of the material in concrete.

After the fines have been processed in the fine grinding device 30, an air classifier 32 can optionally be employed to separate larger particles from smaller particles, and return the larger particles back to the fine grinding device 30 for further processing (for further size reduction and cementitious content liberation). Once the particles are sufficiently ground liberate the cementitious content in the fines and thereby produce a processed recycled concrete paste, the processed recycled concrete paste is collected in a dust collection system 34 that can be a baghouse, cyclone, or both and then moved to a processed recycled concrete paste storage 36, typically in the form of a vertical silo. Alternatively, the processed recycled concrete paste can be moved directly to the processed recycled concrete paste storage 36 without intervening air classifier 32 and dust collection system 34.

Various steps herein can generate airborne dust or particulate matter, including, but not limited to, the screening process 14, rotary drum 16, and screen deck 20. It is recommended that the particulate matter from these systems and processes be prevented from entering the atmosphere by venting the dust-laden air in communication from the system to a baghouse, cyclone, or other dust collection system 38. The dust is composed of smaller particles, many of which possess cementitious value and can be conveyed to the processed recycled concrete paste storage 36 and mixed with the milled processed recycled concrete paste.

The processed recycled concrete paste can be used alone or may be used in a blended or co-milled product with a second supplementary cementitious material. In one embodiment, the second supplementary cementitious material is a ground glass pozzolan (GGP). The GGP may be made via a process described in U.S. Pat. No. 7,775,466, which is hereby incorporated by reference herein in its entirety, or any other suitable process for making a GGP, preferably from, but not limited to, a post-consumer recycled soda lime glass content. The processed recycled concrete paste has reactivity primarily due to the liberation of the unreacted portland cement and secondarily from the liberation other unreacted SCMs such as slag cement, fly ash, etc. The reaction of portland cement in concrete occurs early in the hydration process whereas the pozzolanic reaction from pozzolans is a secondary reaction that provides strength and durability as the concrete ages that cement alone cannot provide. The ground glass pozzolan is added to form a blend adapted to enhance the performance of the processed recycled concrete paste. As such, the combination of the processed recycled concrete paste and the ground glass pozzolan is synergistic. The % processed recycled concrete paste and % GGP used in the blend will depend on the objectives for the blend. The processed recycled concrete paste content can range from 5% to 95% and the GGP can range similarly. Applicant has found that GGP is superior than processed recycled concrete paste at blocking chloride ion penetration. In an exemplar SCM adapted to require superior blocking of chloride ion penetration, a blend of 80% GGP can be used.

Referring to Table 2, one measure of the performance of an SCM is a method contained in ASTM C 311 called Strength Activity Index (SAI). The procedure involves preparation of two sets of mortar cubes, one with cement only and one with 20% of the cement replaced with a SCM. The compressive strengths in pounds per square inch (psi) of each of the mortar cubes are measured after 7 and 28 days. SAI is the ratio of the psi with 20% cement replacement divided the psi of the control with cement only. SAIs of greater than 80% after 7 and 28 days are considered decent and SAIs greater than 90% are considered excellent.

Another measure important to SCM performance is water demand. The strength of a concrete mix is significantly affected by the water to cement ratio (w/c). High w/c ratios produce weaker concrete whereas low w/c ratios produce stronger concrete up to the point where there is insufficient water to react with the cement. SCMs that increase water demand (e.g., natural pozzolans) require the use of water reducer admixtures to decrease the w/c ratio while maintaining fresh concrete workability. GGPs are widely known to reduce water demand and hence the w/c ratio required for workable fresh concrete.

TABLE 2
Concrete Manufactured from Processed Recycled
Cement Paste and Ground Glass Pozzolan (GGP)

| Percent in Sample | | % of Control | | |
|---|---|---|---|---|
| Processed | | | | |
| Recycled | | Water | 7 Day | 28 Day |
| Cement Paste | GGP | Demand | SAI | SAI |
| 100% | | 100% | 86% | 89% |
| 75% | 25% | 99% | 85% | 91% |
| 50% | 50% | 99% | 89% | 90% |
| 25% | 75% | 98% | 88% | 88% |
| | 100% | 98% | 83% | 91% |

Portland cement reacts more quickly than pozzolans in concrete. Therefore, the sample with 100% GGP was expected to have the lowest 7-day SAI but catch up for the 28-day SAI. The results in Table 2 confirmed this hypothesis as the 7-day SAI for the 100% GGP was the lowest at 83%; however, the sample with the GGP was tied for the highest after 28 days. The 28-day SAI for all five mixes ranges from 88% to 91% and these differences are not considered statistically significant. All blends and the 100% GGP mix reduced water demand and the 100% processed recycled concrete paste mix had no effect on water demand. These results indicate that all five blends are suitable SCMs. The result that was unexpected was the performance of the 100% processed recycled concrete paste sample. Scientific literature suggests that only about 10% of the cement in concrete is left unreacted. However, the process described herein sufficiently liberated the unreacted cement, and the SAI results suggest there is more than 10% unreacted portland cement or there is another unknown factor that adds strength.

There have been described and illustrated herein embodiments of methods and systems for the processing of recycled concrete to provide a post-consumer aggregate and a post-consumer cementitious paste that can be used in the manufacture of new concrete as well as other products. While embodiments of the invention have been described, it is not intended that the invention be limited thereto, as it is intended that the invention be as broad in scope as the art will allow and that the specification be read likewise. Thus, while types of systems and machines have been described for carrying out the methods and for being used in the system, it will be appreciated that other systems and machines can be used as well. It will therefore be appreciated by those skilled in the art that yet other modifications could be made to the provided invention without deviating from its scope as claimed.

What is claimed is:

1. A method for removing hardened cement paste from aggregate in a post-consumer crushed concrete material, comprising:
obtaining a post-consumer crushed concrete material including aggregate coated with residual hardened cement paste of a surface area of the aggregate; and
processing the post-consumer crushed concrete material in a rotary drum with lifters,
whereby the processing exposes at least 30% more of the surface area of the aggregate in the sample of the post-consumer crushed concrete material to be free of residual paste.

2. The method of claim 1, wherein the processing exposes at least 40% more of the surface area of the aggregate in the sample of the post-consumer crushed concrete material to be free of residual paste.

3. The method of claim 1, wherein the processing exposes at least 50% more of the surface area of the aggregate in the sample of the post-consumer crushed concrete material to be free of residual paste.

4. The method of claim 1, wherein the rotary drum has a first end, a second end, and a longitudinal axis extending between the first and second ends, and an entrance at the first end, and an exit at the second end such that the post-consumer crushed concrete material is moved from the entrance toward the exit during the processing.

5. The method of claim 4, wherein the rotary drum further includes a heater, and the post-consumer crushed concrete material is heated in the drum during the processing.

6. The method of claim 5, wherein the heater is a parallel flow heater adapted to apply greater heat near the entrance than near the exit.

7. The method of claim 6, further comprising applying water to the post-consumer crushed concrete material before the processing.

8. The method of claim 7, wherein the water is applied with a spray bar.

9. The method of claim 5, wherein the heat is a counter flow heater adapted to apply greater heat near the exit than near the entrance.

10. The method of claim 4, further comprising screening the processed material from the rotary drum to separate the processed material into material of separate sizes categories.

11. The method of claim 10, further comprising grinding a finest of the separated size categories to form a supplementary cementitious material.

12. The method of claim 11, further comprising blending the supplementary cementitious material with a ground glass pozzolan.

13. A method of manufacturing a supplementary cementitious material, comprising:
liberating hardened cement paste from the surface of post-consumer recycled concrete aggregate; and
fine grinding the hardened cement paste to liberate unreacted cement.

14. The method of claim 13, wherein the liberating includes abrading post-consumer concrete aggregate in combination while simultaneously heating the post-consumer concrete aggregate.

15. The method of claim 13, wherein the abrading and heating include processing the post-consumer concrete in a parallel flow heated rotary dryer with lifters.

16. The method of claim 13, wherein the abrading and heating include processing the post-consumer concrete in a counterflow heated rotary dryer with lifters.

17. The method of claim 13, wherein the heating includes heating the hardened cement paste and post-consumer recycled concrete aggregate under conditions such that the hardened cement paste and post-consumer recycled concrete aggregate thermally expand at different rates.

18. The method of claim 13, further comprising:
blending the finely ground hardened cement paste with a second supplementary cementitious material.

19. The method of claim 18, wherein the second supplementary cementitious material is a ground glass pozzolan.

20. A post-consumer recycled aggregate having a surface with a surface area that is at least 30% free of hardened cement paste.

21. The post-consumer recycled aggregate according to claim 20, wherein the surface area is at least 40% free of hardened cement paste.

22. The post-consumer recycled aggregate according to claim 20, wherein the surface area is at least 50% free of hardened cement paste.

23. A post-consumer recycled aggregate made by the process of:
obtaining post-consumer crushed concrete material; and
abrading the post-consumer crushed concrete material in a rotary drum with lifters, the rotary drum having a first end, a second end, a longitudinal axis extending between the first and second ends, an entrance at the first end, and an exit at the second end such that the post-consumer crushed concrete material is moved from the entrance toward the exit during the processing,
whereby the processing while in the rotary drum results in removal of at least 30% percent of the hardened cement paste from the surface of the aggregate.

24. The aggregate of claim 23, wherein the processing results in removal of at least 40% percent of the hardened cement paste from the surface of the aggregate.

25. The aggregate of claim 23, wherein the processing results in removal of at least 50% percent of the hardened cement paste from the surface of the aggregate.

26. The aggregate of claim 23, wherein processing further includes wetting the exterior of the post-consumer crushed concrete material, and then heating while in the drum to cause the aggregate and hardened cement paste to expand at different rates.

27. The aggregate of claim 26, wherein the heat flows in the direction from the entrance to the exit.

28. A supplementary cementitious material (SCM) made by the process of:
processing waste recycled concrete to liberate the unreacted cement; and
milling the unreacted cement.

29. The SCM of claim 28, further comprising:
blending the milled material with a second supplementary cementitious material.

30. The SCM of claim 29, wherein the second supplementary cementitious material is a ground glass pozzolan.
